(19) United States
(12) Patent Application Publication
(10) Pub. No.: US 2005/0195530 A1
(43) Pub. Date: Sep. 8, 2005

(54) Stacked actuator arm assembly with printed circuit card mount

(76) Inventor: Aaron Steve MacPherson, Fort Collins, CO (US)

Correspondence Address: Derek J. Berger;Seagate Technology LLC, Intellectual Property - COL2LGL, 389 Disc Drive, Longmont, CO, 80503, US

(21) Appl. No.: 10/794,667

(22) Filed: Mar. 5, 2004

(51) Int. Cl. G11B 5/55

(52) U.S. Cl. 360/264.2

(57) ABSTRACT

A stacked actuator arm assembly has plural pins and plural support mounts for a printed circuit card. Further the plural pins and plural support mounts are part of a single stacked element of the stacked actuator arm assembly. The card is mounted on the stacked element and attached firmly thereto through at least two pins and support mounts. Further, the printed circuit card and the single stacked element to which it is attached is a subassembly which facilitates final build of the stacked actuator arm assembly. The single stacked element may be a spacer between actuator arms and may be the overmold spacer in the stacked actuator arm assembly. The overmold spacer element has an overmold that carries the actuator coil which when energized rotates the stacked actuator arm assembly. The overmold may also carry pins and support mounts for the printed circuit card.

### FIELD OF THE INVENTION

This application relates generally to disc drives and more particularly to a stacked actuator arm assembly in a disc drive. Further, the stacked actuator arm assembly has a printed circuit card mounted on a single stacked element of the stacked actuator arm assembly.

### BACKGROUND OF THE INVENTION

A typical disc drive includes a base to which various components of the disc drive are mounted. The components include a spindle motor, which rotates one or more discs at a constant high speed. Information is written to and read from tracks on the discs through the use of a stacked actuator arm assembly, which rotates during a seek operation about a bearing shaft assembly positioned adjacent the discs. The stacked actuator arm assembly may include a plurality of actuator arms, which extend towards the discs, with one or more head suspension assemblies extending from each of the actuator arms. Each head suspension assembly includes a flexure or load beam and a head mounted on a gimbal assembly at the distal end of the load beam. Each head includes an air bearing slider enabling the head to fly in close proximity above the corresponding surface of the associated disc. Head suspension assemblies are typically attached to the corresponding metallic actuator arms by a metallic spring member spot welded to the metallic load beams and to the metallic actuator arms. The spring member biases the head suspension assembly towards the surface of the disc.

During a seek operation, the track position of the heads is controlled through the use of a voice coil motor, which typically includes a coil attached to the stacked actuator arm assembly, as well as one or more permanent magnets, which establish a magnetic field in which the coil is immersed. Application of current to the coil causes the coil to move. As the coil moves, the stacked actuator arm assembly pivots about the bearing shaft assembly, and the heads are caused to move across the surfaces of the discs.

During the manufacture of a stacked actuator arm assembly it is most important that the number of subassemblies and parts be minimized to simplify the final automated build of the stacked actuator arm assembly. In the past the printed circuit card mounted on the stacked actuator arm assembly has been fastened to the assembly with one pin. This allowed the card to vibrate excessively during track seek moves of the stacked actuator arm assembly. What was needed was a mounting system for the card to reduce vibration by the card without increasing the number or complexity of subassemblies in the final build of the stacked actuator arm assembly.

### SUMMARY OF THE INVENTION

In accordance with the present invention the above and other problems have been solved by a stacked actuator arm assembly having plural pin mounts and plural support members for a printed circuit card. Further, the plural pins and plural support mounts are part of a single stacked element of the stacked actuator arm assembly. The card is mounted on the stacked element and attached firmly thereto through at least two pins and two supports mounts. The printed circuit card and the single stacked element, to which it is attached, form a subassembly which facilitates final build of the stacked actuator arm assembly.

In another aspect of the invention the printed circuit card is mounted on the overmold spacer in the stacked actuator arm assembly. The overmold spacer has an overmold that carries the actuator coil which when energized rotates the stacked actuator arm assembly. The overmold also carries pins and support mounts for the printed circuit card in addition to the pins and support mounts on the spacer itself.

These and various other aspects and features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a perspective bottom view of an stacked actuator arm assembly illustrating a printed circuit card mounted on a spacer element of the stacked actuator arm assembly according to an embodiment of the present invention.

FIG. 3 is an exploded view of the stacked actuator arm assembly of FIG. 2 containing the printed circuit card and overmold spacer subassembly.

FIG. 4 is a top view of the printed circuit card mounted on pins from the overmold spacer.

FIG. 5 is a perspective view of the overmold spacer subassembly illustrating the support mounts for the printed circuit card.

### DETAILED DESCRIPTION

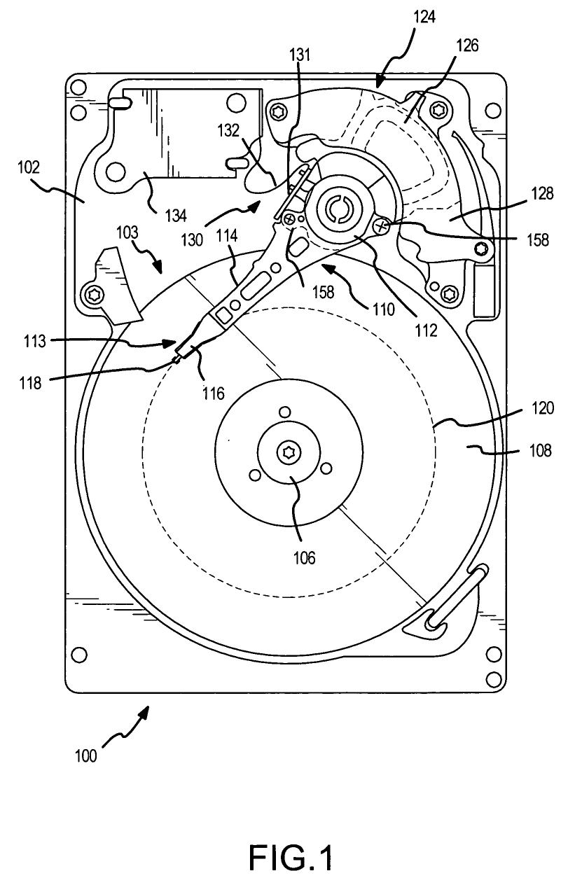

A disc drive 100 constructed in accordance with a preferred embodiment of the present invention is shown in FIG. 1. The disc drive 100 includes a base 102 to which various components of the disc drive 100 are mounted. A top cover, not shown, cooperates with the base 102 to form an internal, sealed environment for the disc drive in a conventional manner. The components include a spindle motor 106, which rotates one or more discs 103 at a constant high speed. Information is written to and read from tracks on the discs 103 through the use of a stacked actuator arm assembly 110, which rotates during a seek operation about a bearing shaft assembly 112 positioned adjacent the discs 103. The actuator assembly 110 includes a plurality of stacked, symmetrical actuator arms 114 which extend towards the discs 103, with one or more head suspension assemblies 113 extending from each of the actuator arms 114. Each head suspension assembly includes a load beam 116, a gimbal assembly (not visible) mounted at the distal end of the load beam and a head 118 mounted on the gimbal assembly. Each actuator arm 114 is a metal arm on which at least one head suspension assembly is mounted. Each head 118 includes an air bearing slider enabling the head 118 to fly in close proximity above a corresponding recording surface 108 of the associated disc 103.

During a seek operation, the track position of the heads 118 is controlled through the use of a voice coil motor 124, which typically includes a coil 126 attached to the actuator assembly 110, as well as one or more permanent magnets 128, which establish a magnetic field in which the coil 126 is immersed. Preferably, the coil 126 is formed as an integral part of a plastic mold extension—the overmold—of a spacer between actuator arms 114. The controlled application of current to the coil 126 causes magnetic interaction between the permanent magnet 128 and the coil 126 so that the coil 126 moves in accordance with the well known Lorentz relationship. As the coil 126 moves, the stacked actuator arm assembly 110 pivots about the bearing shaft assembly 112, and the heads 118 are caused to move across the surfaces of the discs 103.

A flex assembly 130 provides the requisite electrical connection paths for the stacked actuator arm assembly 110 while allowing pivotal movement of the actuator assembly 110 during operation. The flex assembly includes a printed circuit board 131 mounted on one side of the stack of actuator arms 114 and a flex cable 132. The mounting of the printed circuit board or card 131 is described in detail hereinafter. Head wires (not shown) are connected to the printed circuit board; the head wires are routed along the actuator arms 114 and the load beams 116 to the heads 118. The printed circuit board 131 preferably includes circuitry for controlling the write currents applied to the heads 118 during a write operation and a preamplifier for amplifying read signals generated by the heads 118 during a read operation. Additionally, the portion of the head wires that are routed along the actuator arms 114 are preferably a flex circuit attached to actuator arms 114 and load beams 116. The flex assembly also includes a flex cable 132 that extends from the circuit board 131 and terminates at a flex bracket 134. The flex bracket 134 communicates through the base deck 102 to a disc drive printed circuit board (not shown) mounted to the bottom side of the disc drive 100.

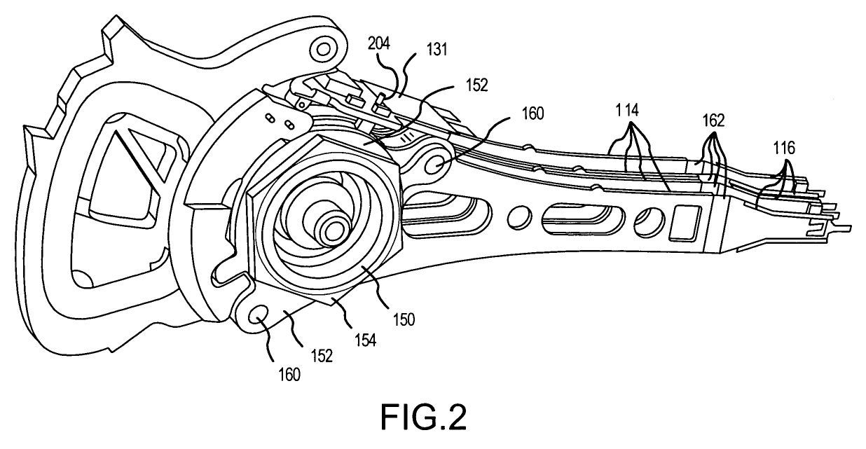

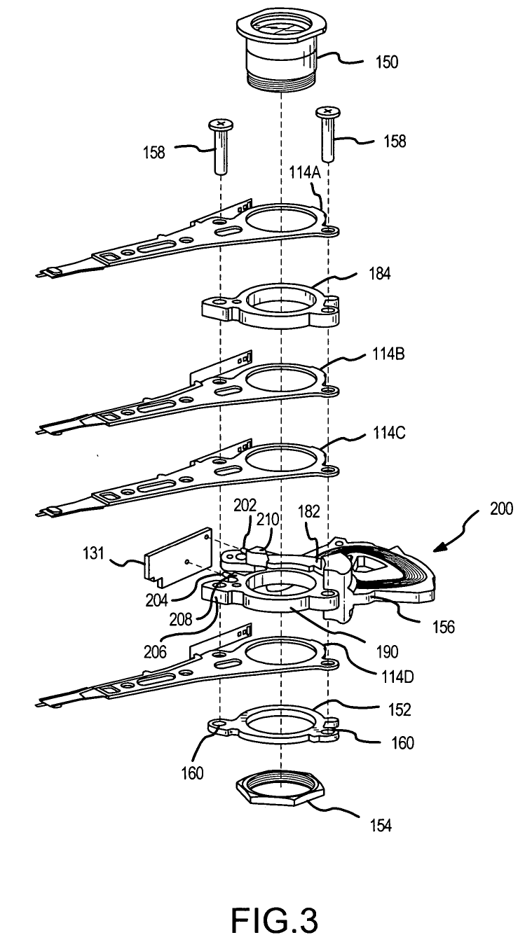

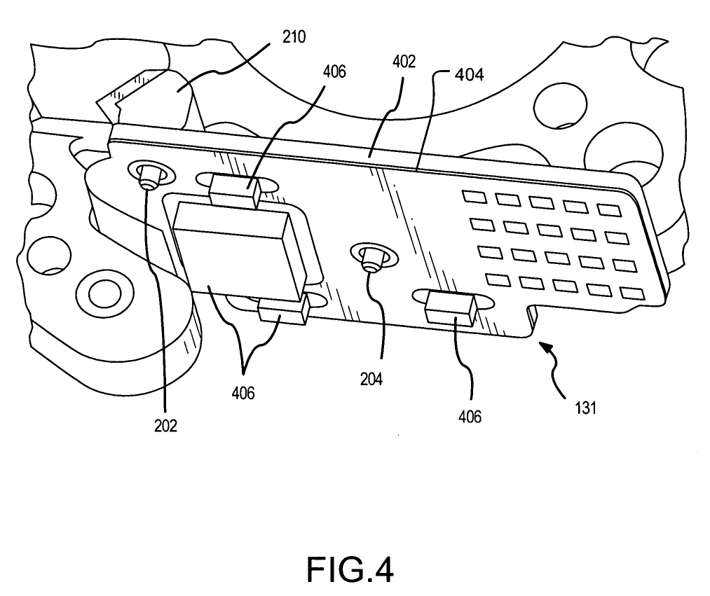

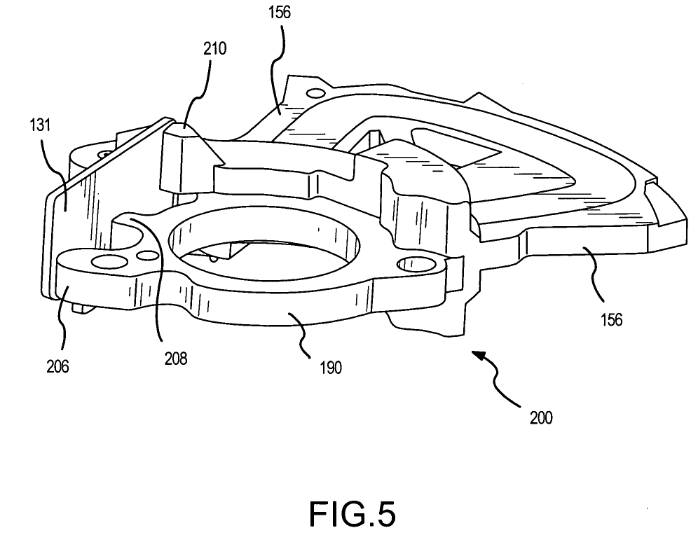

Referring now to FIG. 2, one embodiment of the stacked actuator arm assembly with printed circuit card mount is shown in a bottom perspective view. Printed circuit board 131 is mounted on the overmold spacer. The overmold spacer is made up of spacer 190 (FIG. 3) and a plastic molded extension referred to herein as the overmold 156 (FIG. 3). Printed circuit board 131 is attached at one side of the stacked actuator arm assembly by two solder pins 202 and 204 (FIGS. 3 and 4) mounted in supports (FIGS. 3 and 5) molded in the overmold spacer. The overmold 156 carries one pin as well as the coil 126 of the voice coil motor to rotate the stacked actuator arm assembly. The spacer 190 on which the overmold is molded carries the other pin.

The stacked assembly is made up of four actuator arms 114 with spacers between the outer actuator arms and the inner actuator arms. The actuator arms and the spacers are stacked on sleeve or hub 150 of bearing shaft assembly 112 (FIG. 1). A nut washer 152 is placed between the last actuator arm on the stack and a clamping nut 154. Nut 154 is threaded on the bottom of sleeve 150 to clamp the stacked actuator arm assembly together. The nut washer serves to distribute the compression load of the nut on the stacked assembly as the nut is tightened down.

In addition to the nut 154 holding the stacked actuator arm assembly together, there are also provided two threaded pins, (bolts or screws) 158 (FIG. 1) that pass through aligned holes in all of the stacked actuator arm assembly elements and are threaded into the holes 160 in nut washer 152. The screws 158 serve multiple functions. They provide fasteners in addition to nut 154 to hold the stacked actuator arm assembly together, and they compress the stack of elements making the stacked actuator arm assembly more rigid.

The load beams 116 are attached to the actuator arms by spring members 162 which provide a spring force to load the heads 118 (FIG. 1) adjacent the surface of the discs 103 (FIG. 1) as the heads are flying above the surface. A flex cable (not shown) passes from the printed circuit board 131 to the actuator arms to the load beams and ultimately to the heads 118.

FIG. 3 shows an exploded view of the stacked actuator arm assembly and illustrates how the printed circuit card and overmold spacer subassembly 200 fits into the stack. Each of the arms 114A, 114B, 114C and 114D are stacked on the hub 150. The top arm 114A is spaced from arm 114B by spacer 184 so that a disc may rotate between arms 114A and 114B. Arms 114B and 114C are stacked adjacent to each other. Arms 114C and 114D are separated by the spacer 190 so that a second disc may rotate between arms 114C and 114D. Spacer 190 carries the overmold 156. Spacer 190 also carries two mounts 206 and 208 for supporting the printed circuit card 131. Overmold 156 also carries a mount 210 for supporting the printed circuit card 131. Mount 210 and mount 208 contain pins 202 and 204 respectively to hold the card 131 against the mounts 206, 208 and 210. Together, the overmold spacer i.e. spacer 190 and overmold 156, along with card 131 form the overmold spacer subassembly 200 that may be stacked as a single unit on hub 150 when assembling the stacked actuator arm assembly.

The stacked actuator arm assembly is completed by adding washer 152 to the stack and threading nut 154 onto the threads at the bottom of hub or sleeve 150. With all elements in the stack in proper alignment screws 158 will pass through holes in the arms and spacers and screw into threaded holes 160 in washer 152.

FIG. 4 is a close-up view of the printed circuit card 131 mounted on the overmold spacer. Card 131 is made up of a support substrate 402 and a printed circuit layer 404. Circuit chips 406 are mounted on the printed circuit board 131. Pin 202 from mount 210 on overmold 156 protrudes through solder holes in substrate 402 and printed circuit layer 404. Pin 204 from mount 208 (FIGS. 3 and 5) on spacer 190 protrudes through solder holes in substrate 402 and printed circuit layer 404. To attach the card to the overmold spacer, the card 131 is pressed against support mounts 206, 208, and 210, and pins 202 and 204 are soldered to the printed circuit layer and substrate to hold the card firmly in place. Of course threaded fasteners or push-on fasteners or adhesives could be used to fasten the card to the pins against the support mounts. Soldering the pins to the printed circuit layer and substrate is preferred as it simplifies removal of the card if necessary when reworking the stacked actuator arm assembly.

This embodiment of the invention provides three support mounts and two pins of attachment to securely mount the printed circuit card 131 on the overmold spacer and minimize vibration of the card during high frequency seek operations by the actuator arm. There could also be a pin in support mount 206 if three pins are desired. If only two pins are to be used, they might be placed in any two of the support mounts 206, 208 and 210.

FIG. 5 illustrates the overmold spacer subassembly 200, i.e. card 131 and the overmold spacer made up of spacer 190 and overmold 156. Spacer 190 carries support mounts 206 and 208, while overmold 156 carries support mount 210. Card 131 is held firmly against support mounts 206, 208 and 210 when soldered to pins 202 and 204 (FIG. 4). The overmold spacer subassembly 200 is easily assembled into the stacked actuator arm assembly as depicted in FIG. 3.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, many different locations for mounting pins and supports may be used to mount the printed circuit card on a spacer element in accordance with the present invention. Supports and pins might be added to a second spacer element for the purpose of mounting the printed circuit card on a stacked element other than the overmold spacer carrying the actuator coil. Also more than two pins might be used and two or more mounting supports might be used.

Numerous other changes may be made which will readily suggest themselves to those skilled in the art and which are encompassed in the spirit of the invention disclosed and as defined in the appended claims.

1. An actuator arm assembly for accessing data on a storage medium in a data storage device, the actuator arm assembly comprising:
a rotatable sleeve;
an actuator arm mounted on the sleeve;
a stacked element mounted on the sleeve with the actuator arm;
a plurality of pins mounted on the stacked element; and
a printed circuit card mounted on the plurality of pins to reduce vibration during movement of the actuator arm assembly and to form a single subassembly with the stacked element.

2. The actuator arm assembly of claim 1 further comprising:
a plurality of supports on the stacked element, the supports supporting the printed circuit card;
each of the pins being carried by a support; and
the printed circuit card held against the supports by the pins.

3. The actuator arm assembly of claim 2 wherein the actuator arm assembly further comprises:
the pins passing through holes in the printed circuit card and being soldered to the card.

4. The actuator arm assembly of claim 2 wherein there are three supports and one pin each on two of the supports.

5. The actuator arm assembly of claim 2 wherein the stacked element is an overmold spacer that has an overmold for carrying a motive coil for the actuator arm assembly.

6. The actuator arm assembly of claim 5 wherein at least one pin and at least one support is carried by the overmold.

7. The actuator arm assembly of claim 5 further comprising:
at least one additional actuator arm and at least one additional spacer mounted on the sleeve.

8. In a disc drive having a plurality of rotatable discs and a stacked actuator arm assembly operable to move at least one read/write head over each recording surface of the rotatable discs, the stacked actuator arm assembly comprising:
a plurality of stacked actuator arms, each arm carrying a read/write head;
a sleeve rotatably mounted on the disc drive and carrying the actuator arms in stacked array along the axis of the sleeve;
one or more spacers also mounted on the sleeve, a spacer being mounted between actuator arms carrying read/write heads for opposite sides of a rotatable disc so that the spacer provides separation between the arms to accommodate the rotatable disc positioned between the arms; and
at least one of the spacers carrying a printed circuit card; and
the printed circuit card mounted between a plurality of supports and pins on the spacer whereby the printed circuit card is attached to the spacer at more than one point to reduce vibration in the printed circuit card during track seek operations.

9. The stacked actuator arm assembly of claim 8 wherein:
the pins pass through solder holes in the printed circuit card;
the printed circuit card rests against the supports; and
the pins are soldered to the printed circuit card holding the card firmly against the supports.

10. The stacked actuator arm assembly of claim 8 further comprising:
an overmold on the spacer carrying the printed circuit card; and
the supports and pins located on both the spacer and the overmold for mounting the printed circuit card.

11. The stacked actuator arm assembly of claim 8 wherein there are at least two supports and two pins for mounting the printed circuit card.

12. A spacer subassembly for a stacked actuator arm assembly, the subassembly comprising:
a spacer providing space between actuator arms in the stacked actuator arm assembly and carrying supports with pins on the supports;
a printed circuit card mounted on at least two of the supports and attached to at least two of the pins whereby vibration is minimized in the printed circuit card during movement of the stacked actuator arm assembly.

13. The spacer subassembly of claim 12 wherein the pins pass through solder holes in the printed circuit card and the card is soldered to the pins.

14. The spacer subassembly of claim 12 further comprising:
an overmold molded on the spacer;
the overmold carrying supports with pins on the supports so that the printed circuit card is attached to pins on the spacer and is also attached to pins on the overmold.

15. The spacer subassembly of claim 14 wherein:
the spacer has two supports;
the overmold has one support;
one support on the spacer has a pin for mounting the printed circuit card; and
the support on the overmold has a pin for mounting the printed circuit card.
